(19) United States
(12) Patent Application Publication
(10) Pub. No.: US 2026/0278124 A1
(43) Pub. Date: Sep. 17, 2026

(54) CONTROLLING DEPLOYMENT OF CONTAINER OBJECT WITHIN CONTAINER PLATFORM

(71) Applicant: International Business Machines Corporation, Armonk, NY (US)

(72) Inventors: Qi Feng Huo, BEIJING (CN); Da Li Liu, BEIJING (CN); YUAN YUAN WANG, BEIJING (CN); Yan Song Liu, BEIJING (CN); Lei Li, BEIJING (CN)

(21) Appl. No.: 19/077,069

(22) Filed: Mar. 12, 2025

(51) Int. Cl. G06F 21/60; G06F 21/51; G06F 21/55

(52) U.S. Cl. CPC G06F 21/604; G06F 21/51; G06F 21/554

(57) ABSTRACT

Controlling a deployment of a container object within a container platform requires a response to a request associated with the deployment of the container object within the container platform to be intercepted. The response is transmitted from a set of admission controllers associated with the container platform. One or more policies from a set of defined policies are retrieved based on the request. The one or more policies are applied on the request. A result of the application of the one or more policies on the request is determined. The result is indicative of a denial of the request. The intercepted response is compared with the determined result. An anomaly is identified based on the comparison. The deployment of the container object within the container platform is controlled based on the identified anomaly.

### BACKGROUND

The disclosure relates to container objects and more particularly, to the deployment of the container object.

A container platform is a software framework that enables deployment, management, and orchestration of containerized applications, providing a consistent environment for development and production of the containerized application. Admission controllers are critical components within container platforms that enforce policies and manage admission of requests to a cluster within the container platforms. The admission controllers represent an advancement in management and customization of the clusters (such as Kubernetes® clusters), serving as vital interceptors that process the admission requests before their persistence in an Application Programming Interface (API) server (such as Kubernetes® API server). The admission controllers, particularly through the use of admission webhooks, manage consistent application of policies across the cluster, thereby enhancing operational efficiency and compliance with organizational standards.

### SUMMARY

In various embodiments of the disclosure, a computer-implemented method for controlling a deployment of container object within a container platform is described. The computer-implemented method includes intercepting, by a computer, a response to a request associated with a deployment of a container object within a container platform. The response is transmitted from a set of admission controllers associated with the container platform. The computer-implemented method further includes retrieving, by the computer, one or more policies from a set of defined policies based on the request. The computer-implemented method further includes determining, by the computer, a result based on the application of the one or more policies on the request. The result is indicative of a denial of the request. The computer-implemented method further includes comparing, by the computer, the intercepted response with the determined result. The comparison indicates that the determined result is different from the intercepted response. The computer-implemented method further includes identifying, by the computer, an anomaly associated with the set of admission controllers based on the comparison. The computer-implemented method further includes controlling, by the computer, the deployment of the container object within the container platform based on the identified anomaly.

In various embodiments of the disclosure, a computer system for controlling the deployment of the container object within the container platform is described. The computer system includes a processor set, a computer-readable storage media, and program instructions that are stored on the one or more computer-readable storage media. The program instructions are executable by the processor set to cause the processor set to control a set of admission controllers to generate a response to a request associated with a deployment of a container object within a container platform. The set of admission controllers receives the request from an Application Programming Interface (API) server. The program instructions further cause the processor set to intercept the response to the request. The response is transmitted from the set of admission controllers associated with the container platform. The program instructions further cause the processor set to retrieve one or more policies from a set of defined policies based on the request. The program instructions further cause the processor set to apply the one or more policies on the request. The program instructions further cause the processor set to determine a result based on the application of the one or more policies on the request. The result is indicative of an allowance of the request. The program instructions further cause the processor set to compare the intercepted response with the determined result. The comparison indicates that the determined result is identical to the intercepted response. The program instructions further cause the processor set to control the deployment of the container object within the container platform based on the comparison.

In various embodiments of the disclosure, a computer-programmable product for controlling the deployment of the container object within the container platform is described.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for controlling a deployment of a container object within a container platform, in accordance with an embodiment of the disclosure;

FIG. 2 is a diagram that illustrates an environment for controlling the deployment of the container object within the container platform, in accordance with an embodiment of the disclosure;

FIG. 3A is a block diagram that illustrates one or more operations for controlling the deployment of the container object within the container platform, in accordance with an embodiment of the disclosure;

FIG. 3B is a block diagram that illustrates one or more operations executed based on a comparison of determined result with an intercepted response, in accordance with an embodiment of the disclosure;

FIG. 4 is a flowchart that illustrates retrieval of the one or more policies, in accordance with an embodiment of the disclosure;

FIG. 5A is a flowchart that illustrates a reception of an acknowledgment from the API server associated with the container platform, in accordance with an embodiment of the disclosure;

FIG. 5B is a block diagram that illustrates a generation of an alert based on the reception of the acknowledgment, in accordance with an embodiment of the disclosure;

FIG. 6 is a block diagram that illustrates a modification of the request by the set of admission controllers, in accordance with an embodiment of the disclosure;

FIG. 7 illustrates a flowchart of a first exemplary method for controlling the deployment of the container object within the container platform, in accordance with an embodiment of the disclosure; and

FIG. 8 illustrates a flowchart of a second exemplary method for controlling the deployment of the container object within the container platform, in accordance with an embodiment of the disclosure.

### DETAILED DESCRIPTION

A container platform is a software framework that enables deployment, management, and orchestration of applications within lightweight, portable containers. These containers encapsulate an application and its dependencies, ensuring consistent performance across various environments, from development to production. The applications are hosted on the container platforms for several reasons, such as, but not limited to, improved resource efficiency, scalability, and isolation. By utilizing containers, organizations or users (such as Development and Operations (DevOps) engineers) can achieve faster deployment cycles, simplify application updates, and enhance the reliability of the application. Additionally, the container platform manages microservices architecture, allowing users (such as the DevOps engineers) to build and deploy the applications as a collection of loosely coupled services, which can be independently managed and scaled.

Admission controllers are critical components in the container platform. The admission controllers act as gatekeepers that intercept requests to the API server before the requests have persisted in the cluster. The admission controllers enable administrators to enforce policies and validate configurations, ensuring that only compliant and secure resources (such as container objects) are created or modified. By implementing the admission controllers, the organizations or the users can maintain control over containerized applications, applying rules related to security, resource quotas, and naming conventions. This helps prevent misconfigurations and enhances the overall stability and security of the container platform, allowing for a more controlled and predictable deployment environment.

Further, for hosting the applications on the container platform, the admission controllers play a central role in managing the lifecycle of the containers and resources associated with the containers. For instance, the admission controllers can enforce policies that restrict use of certain container images, ensuring that only trusted container images are deployed within the applications. Additionally, the admission controllers can automatically inject sidecar containers for logging or monitoring, enhancing observability without requiring manual intervention. By leveraging the admission controllers, the organizations or the users can streamline the deployment process while adhering to best practices and compliance requirements, leading to more robust and secure application hosting on the container platform.

Traditionally, there are some problems faced by the admission controllers including risk of malicious misconfiguration and inadequate policy enforcement. If an attacker, that may be a malicious actor, gains access to the configuration of the admission controllers, the malicious actor could alter rules and policies to bypass security measures, allowing unauthorized or insecure resources to be deployed within the applications. Additionally, the admission controllers may struggle with complex policy management, leading to inconsistencies and gaps in enforcement. Further, performance issues can arise when the admission controllers become bottlenecks, slowing down the API server's response time. Furthermore, maintaining and updating the admission controllers can be challenging, as evolving application requirements and evolving malicious attacks necessitate frequent changes to policies, increasing the potential for errors and vulnerabilities.

To overcome the abovementioned problems, the disclosure discloses a method that introduces a Secure Admission Controller Management (SACM) system. The Secure Admission Controller Management (SACM) system, operates within a trusted execution environment (TEE). This approach ensures that the integrity and security of the admission controllers are maintained throughout the lifecycle. The SACM rigorously checks the requests that originate from the admission controllers against defined policies. The defined policies serve as a benchmark for acceptable behavior and configurations associated with the admission controllers. By validating the requests, the SACM can effectively determine whether the admission controllers are functioning correctly and adhering to security protocols.

For instance, if the SACM identifies that the request from a validating admission controller has been incorrectly validated, which indicates that the validating admission controller allowed an unauthorized resource to be created within the application, the SACM will flag this anomaly. The anomaly indicates that the validating admission controller may be compromised or misconfigured. Similarly, if a mutating admission controller is found to be altering resources inappropriately, the SACM executes a resolution process. In such cases, the SACM will automatically delete the compromised admission controller and replace it with a new, secure instance of the admission controller. This proactive management not only enhances the security of the container platform but also ensures that application deployments remain consistent and compliant with organizational policies.

By operating within the TEE, the SACM ensures that the admission controllers' operations are isolated from potential threats. This secure environment protects against unauthorized access and tampering, thereby maintaining the integrity of the SACM. The ability of the SACM to validate requests against defined policies further strengthens security by preventing the deployment of malicious or misconfigured resources.

The capability of the SACM to identify anomalies in the admission controllers allows for rapid identification of compromised components. When the misconfiguration or malicious activity is identified, the SACM deletes the affected admission controller and replaces it with the new instance. This process minimizes downtime and reduces the risk of security breaches, ensuring that the container platform remains resilient and operational.

The SACM enforces defined policies consistently across various admission controllers, ensuring that the requests are evaluated against security standards. This uniformity helps prevent discrepancies that could arise from manual configurations or varying interpretations of policies. As a result, the organizations or the users can achieve greater compliance with regulatory requirements and internal standards, leading to a more reliable and predictable deployment process.

In various embodiments of the disclosure, a computer-implemented method for controlling a deployment of container object within a container platform is described. The computer-implemented method includes intercepting, by a computer, a response to a request associated with a deployment of a container object within a container platform. The response is transmitted from a set of admission controllers associated with the container platform. The computer-implemented method further includes retrieving, by the computer, one or more policies from a set of defined policies based on the request. The computer-implemented method further includes determining, by the computer, a result based on the application of the one or more policies on the request. The result is indicative of a denial of the request. The computer-implemented method further includes comparing, by the computer, the intercepted response with the determined result. The comparison indicates that the determined result is different from the intercepted response. The computer-implemented method further includes identifying, by the computer, an anomaly associated with the set of admission controllers based on the comparison. The computer-implemented method further includes controlling, by the computer, the deployment of the container object within the container platform based on the identified anomaly.

In various embodiments of the disclosure, the computer-implemented method further includes retrieving, by the computer, the set of defined policies associated with the container platform. The computer-implemented method further includes identifying, by the computer, the one or more policies from the retrieved set of defined policies based on the request. The computer-implemented method further includes retrieving, by the computer, the one or more policies from the set of defined policies based on the identification.

In various embodiments of the disclosure, the computer-implemented method further includes identifying, by the computer, the determined result is different from the intercepted response. The identification is based on the comparison of the intercepted response with the determined result. The computer-implemented method further includes identifying, by the computer, the anomaly associated with the set of admission controllers based on the identification that the determined result is different from the intercepted response. The computer-implemented method further includes executing, by the computer, a resolution process to rectify the identified anomaly associated with the set of admission controllers. The computer-implemented method further includes deploying, by the computer, the container object within the container platform based on the execution of the resolution process.

In various embodiments of the disclosure, the resolution process includes one of a deletion of an admission controller of the set of admission controllers associated with the container platform or a creation of the admission controller of the set of admission controllers associated with the container platform.

In various embodiments of the disclosure, the computer-implemented method further includes generating, by the computer, a deployment request associated with the deployment of the container object within the container platform. The computer-implemented method further includes transmitting, by the computer, the deployment request to an Application Programming Interface (API) server associated with the container platform. The computer-implemented method further includes receiving, by the computer, an acknowledgment from the API server. The acknowledgment is indicative of a reception of the deployment request by the API server.

In various embodiments of the disclosure, the computer-implemented method further includes generating, by the computer, an alert based on the reception of the acknowledgment. The computer-implemented method further includes outputting, by the computer, the generated alert on a user device.

In various embodiments of the disclosure, the computer-implemented method further includes controlling, by the computer, an Application Programming Interface (API) server associated with the container platform to receive the request associated with the deployment of the container object within the container platform. The computer-implemented method further includes controlling, by the computer, the API server to execute an authentication operation on the received request to generate an authenticated request. The computer-implemented method further includes controlling, by the computer, the API server to transmit the authenticated request to the set of admission controllers.

In various embodiments of the disclosure, the computer-implemented method further includes controlling, by the computer, the set of admission controllers to receive the authenticated request transmitted from the API server. The computer-implemented method further includes controlling, by the computer, the set of admission controllers to execute a modification operation on the authenticated request. The modification operation is executed to generate a modified request. The computer-implemented method further includes controlling, by the computer, the set of admission controllers to generate the response to the modified request. The response corresponds to an allowance of the modified request. The computer-implemented method further includes intercepting, by the computer, the response associated with the modified request.

In various embodiments of the disclosure, the modification operation corresponds to one of a validation operation or a mutation operation. The validation operation corresponds to a determination that the authenticated request is based on the one or more policies of the set of defined policies. The mutation operation corresponds to a mutation of the authenticated request.

In various embodiments of the disclosure, a computer system for controlling the deployment of the container object within the container platform is described. The computer system includes a processor set, a computer-readable storage media, and program instructions that are stored on the one or more computer-readable storage media. The program instructions are executable by the processor set to cause the processor set to control a set of admission controllers to generate a response to a request associated with a deployment of a container object within a container platform. The set of admission controllers receives the request from an Application Programming Interface (API) server. The program instructions further cause the processor set to intercept the response to the request. The response is transmitted from the set of admission controllers associated with the container platform. The program instructions further cause the processor set to retrieve one or more policies from a set of defined policies based on the request. The program instructions further cause the processor set to apply the one or more policies on the request. The program instructions further cause the processor set to determine a result based on the application of the one or more policies on the request. The result is indicative of an allowance of the request. The program instructions further cause the processor set to compare the intercepted response with the determined result. The comparison indicates that the determined result is identical to the intercepted response. The program instructions further cause the processor set to control the deployment of the container object within the container platform based on the comparison.

In various embodiments of the disclosure, the program instructions further cause the processor set to control the API server associated with the container platform to receive the request associated with the deployment of the container object within the container platform. The request is received by the API server for an authentication of the request. The program instructions further cause the processor set to control the API server to execute an authentication operation on the received request to generate an authenticated request. The program instructions further cause the processor set to control the API server to transmit the authenticated request to the set of admission controllers.

In various embodiments of the disclosure, the program instructions further cause the processor set to control the set of admission controllers to receive the authenticated request transmitted from the API server. The program instructions further cause the processor set to control the set of admission controllers to execute a modification operation on the authenticated request. The modification operation is executed to generate a modified request. The program instructions further cause the processor set to control the set of admission controllers to generate the response to the modified request. The response corresponds to an allowance of the modified request.

In various embodiments of the disclosure, the modification operation corresponds to one of a validation operation or a mutation operation. The validation operation corresponds to a determination that the authenticated request is based on the one or more policies of the set of defined policies. The mutation operation corresponds to a mutation of the authenticated request.

In various embodiments of the disclosure, the program instructions further cause the processor set to retrieve the set of defined policies associated with the container platform. The program instructions further cause the processor set to identify the one or more policies from the retrieved set of defined policies based on the request. The program instructions further cause the processor set to retrieve the one or more policies from the set of defined policies based on the identification.

In various embodiments of the disclosure, the program instructions further cause the processor set to retrieve the set of defined policies associated with the container platform. The program instructions further cause the processor set to identify the one or more policies from the retrieved set of defined policies based on the modified request. The program instructions further cause the processor set to retrieve the one or more policies from the set of defined policies based on the identification.

In various embodiments of the disclosure, the program instructions further cause the processor set to identify the determined result is identical to the intercepted response. The identification is based on the comparison of the intercepted response with the determined result. The program instructions further cause the processor set to deploy the container object within the container platform based on the identification that the determined result is identical to the intercepted response.

In various embodiments of the disclosure, the program instructions further cause the processor set to generate a deployment request associated with the deployment of the container object within the container platform. The program instructions further cause the processor set to transmit the deployment request to the API server. The program instructions further cause the processor set to receive an acknowledgment from the API server. The acknowledgment is indicative of a reception of the deployment request by the API server.

In various embodiments of the disclosure, the program instructions further cause the processor set to generate an alert based on the reception of the acknowledgment. The program instructions further cause the processor set to output the generated alert on a user device.

In various embodiments of the disclosure, a computer program product for controlling the deployment of the container object within the container platform is described. The computer program product includes a computer-readable storage media having program instructions stored on the computer-readable storage media to perform operations. The operations include intercepting a response to a request associated with the deployment of the container object within the container platform. The response is transmitted from a set of admission controllers associated with the container platform. The operations further include retrieving one or more policies from a set of defined policies based on the request. The operations further include applying the one or more policies on the request. The operations further include determining a result based on the application of the one or more policies on the request. The result is indicative of a denial of the request. The operations further include comparing the intercepted response with the determined result. The comparison indicates that the determined result is different from the intercepted response. The operations further include identifying an anomaly associated with the set of admission controllers based on the comparison. The operations further include controlling the deployment of the container object within the container platform based on the identified anomaly.

In various embodiments of the disclosure, the operations further include retrieving the set of defined policies associated with the container platform. The operations further include identifying the one or more policies from the retrieved set of defined policies based on the request. The operations further include retrieving the one or more policies from the set of defined policies based on the identification.

In various embodiments of the disclosure, the operations further include identifying the determined result is different from the intercepted response. The identification is based on the comparison of the intercepted response with the determined result. The operations further include identifying the anomaly associated with the set of admission controllers based on the identification that the determined result is different from the intercepted response. The operations further include executing a resolution process to rectify the identified anomaly associated with the set of admission controllers. The operations further include deploying the container object within the container platform based on the execution of the resolution process.

Various aspects of the disclosure are described by narrative text, flowcharts, block diagrams of computer systems, and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory when stored.

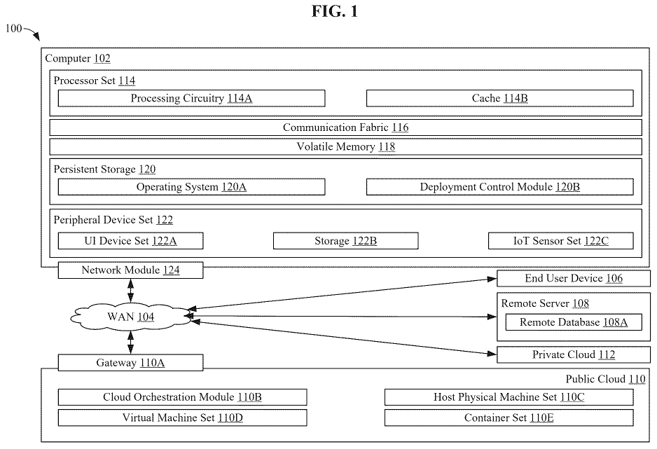

FIG. 1 is a diagram that illustrates a computing environment controlling the deployment of the container object within the container platform, in accordance with an embodiment of the disclosure. With reference to FIG. 1, there is shown a computing environment 100 that contains an example of an environment for the execution of at least some of the computer code involved in performing the disclosed methods, such as a deployment control module 120B. In addition to the deployment control module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the deployment control module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is configured for running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not vital to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the deployment control module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not vital unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the deployment control module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is vital to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) is configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

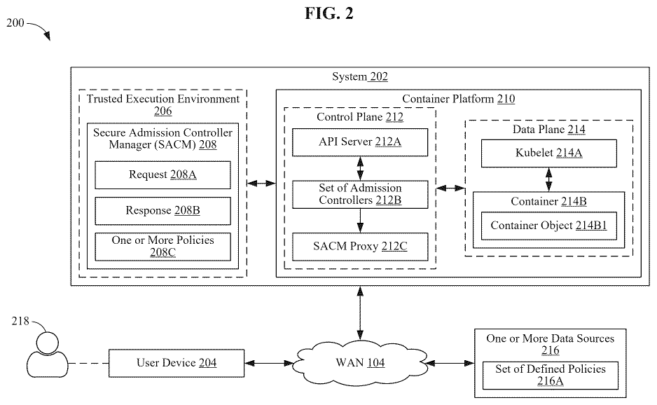

FIG. 2 is a diagram that illustrates an environment for controlling the deployment of the container object within the container platform, in accordance with an embodiment of the disclosure. FIG. 2 is explained in conjunction with elements from FIG. 1. With reference to FIG. 2, there is shown a diagram of a network environment 200. The network environment 200 includes a computer system (hereinafter referred to as system 202), a user device 204, and one or more data sources 216. The system 202 further includes a Trusted Execution Environment (TEE) 206 and a container platform 210. The TEE 206 further includes a Secure Admission Controller Manager (SACM) 208. The SACM 208 further includes a request 208A, a response 208B, and one or more policies 208C. The container platform 210 further includes a control plane 212 and a data plane 214. The control plane 212 further includes an Application Programming Interface (API) server 212A, a set of admission controllers 212B, and a SACM proxy 212C. The data plane 214 further includes a kubelet 214A and a container 214B. The container 214B further includes a container object 214B1. The user device 204 is further associated with a user 218 (a Development and Operations (DevOps) engineer). The network environment 200 further includes the WAN 104 of FIG. 1. In an embodiment of the disclosure, the user device 204 is an exemplary embodiment of the EUD 106. Similarly, the system 202 is an exemplary embodiment of the computer 102 in FIG. 1.

The system 202 is configured to intercept the response 208B to the request 208A associated with the deployment of the container object 214B1 within the container platform 210. The response 208B is transmitted from the set of admission controllers 212B associated with the container platform 210. The system 202 further retrieves the one or more policies from a set of defined policies 216A based on the request 208A. Further, the system 202 applies the one or more policies 208C on the request 208A. The system 202 further determines a result based on the application of the one or more policies 208C on the request 208A. In an embodiment, the system 202 determines that the result is indicative of a denial of the request 208A. Further, the system 202 compares the intercepted response 208B with the determined result. In an embodiment, the comparison indicates that the determined result is different from the intercepted response 208B. In an embodiment, based on the comparison indicating that the determined result is different from the intercepted response 208B, the system 202 is further configured to identify an anomaly associated with the set of admission controllers 212B. Further, the system 202 controls the deployment of the container object 214B1 within the container platform 210 based on the identified anomaly.

In an alternate embodiment, based on the determination of the result, the system 202 determines that the result is indicative of an allowance of the request 208A. Further, the system 202 compares the intercepted response 208B with the determined result. Further, based on the comparison, the system 202 determines that the comparison indicates that the determined result is identical to the intercepted response 208B. Further, the system 202 controls the deployment of the container object 214B1 within the container platform 210 based on the comparison.

Examples of the system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 may be embodied as a cloud-based service, a cloud-based application, a cloud-based platform, a remote server-based service, a remote server-based application, a remote server-based platform, or a virtual computing system. By way of example, and not by limitation, the system 202 may correspond to the SACM 208 configured to execute within the TEE 206.

The request 208A associated with the deployment of the container object 214B1 within the container platform 210 may be initiated by the user 218 or an automated system via the API server 212A such as the Kubernetes® API server. In an embodiment, the API server 212A may be present within the control plane 212. In an embodiment, the control plane 212 is configured to manage overall state of a cluster associated with the container platform 210. The control plane 212 orchestrates the deployment, scaling, and operation of containerized applications. The control plane 212 includes components such as, but not limited to, the API server 212A, the set of admission controllers 212B, and the SACM proxy 212C. By monitoring the cluster, the control plane 212 ensures that the actual state of the containerized applications satisfies specific configurations configured by the user 218.

In an embodiment, the request 208A can be initiated using a kubect command-line tool, client libraries, or through a custom application that interacts with the Kubernetes® API server. The request 208A includes a manifest file (such as Yet Another Markup Language (YAML) file or JavaScript Object Notation (JSON) file) that defines a desired state of the container object 214B1, such as a pod or deployment, specifying details like container images, resource limits, and networking configurations. Upon receiving the request 208A, the control plane 212 associated with the container platform 210 processes the request 208A, schedules the container object 214B1, and manages lifecycle of the container object 214B1 within the container platform 210.

The one or more policies 208C may include a resource quota policy. The resource quotas policy limits amount of Central Processing Unit (CPU) and memory that can be allocated to a specific namespace or the containerized application. The one or more policies 208C may include a health monitoring policy. In an embodiment, the system 202 is configured to regularly check the health and status of the set of admission controllers 212B associated with the container platform 210 to ensure that the set of admission controllers 212B is running and responsive. In an embodiment, the one or more policies 208C may include a webhook configuration validation policy. The webhook configuration validation policy verifies the configuration of a validating admission controller and a mutating admission controller to ensure the validating admission controller and the mutating admission controller are correctly set up and active. Further, the one or more policies 208C may include an API resource verification policy. The API resource verification policy checks that every expected API resource is available and functioning properly within the cluster where the containerized application is running. The one or more policies 208C may further include a policy assignment confirmation. The policy assignment confirmation ensures that various policy assignments (e.g., ConstraintTemplates) are applied and active in the cluster associated with the application. In an embodiment, the policy assignments are configurations that link specific policies to resources or groups within the container platform 210, ensuring that defined rules and guidelines are enforced. The one or more policies 208C may further include an audit logging policy. The audit logging policy may monitor audit logs for any denied requests or errors related to policies associated with the set of admission controllers to identify potential anomalies.

The container platform 210 includes suitable logic, circuitry, interfaces, and/or code that may be configured to host an application within the cluster associated with the container platform 210. The container platform 210 is a software framework that enables the deployment, management, and scaling of containerized applications. The container platform 210 provides a consistent runtime environment by encapsulating the application and the dependencies of the application within the container 214B, ensuring seamless operation across various computing environments. The container platform 210 offers tools and services for orchestrating containers, optimizing resource utilization, and automating tasks such as scaling and fault tolerance. Examples of different types of the container platform 210 include but are not limited to, container engines (such as Docker®), container orchestrators (such as the Kubernetes® and OpenShift®), and managed container platforms.

In an embodiment, the application is hosted on the container platform 210. Specifically, hosting the application on the container platform 210 involves several key steps to ensure it runs efficiently and reliably. Firstly, a docker file is created to define the environment of the application, dependencies, and relevant instructions to build the application image. An application image is then pushed to a container registry. Further, deployment configurations, typically using Yet Another Markup Language (YAML) files, are crafted to define the desired state of the application, specifying details such as the number of replicas, resource limits, and networking requirements. Such configurations are applied using container orchestration tools like Kubernetes®, which manage the deployment, scaling, and operation of the application containers across a cluster of nodes. Additional configurations might include setting up persistent storage, configuring environment variables and secrets for sensitive data, and setting up monitoring and logging to track the application's performance and health.

In container platform 210, the cluster corresponds to a set of interconnected nodes that work together to manage and orchestrate containerized applications. Each cluster typically consists of the control plane (master node) that oversees the cluster's operations and multiple worker nodes that run the containers. The cluster enables efficient resource utilization, scaling, and high availability by distributing workloads across nodes. Further, the cluster manages automated deployment, the scaling, and management of the containers, ensuring that the application remains resilient and responsive. Container orchestration tools like the Kubernetes®, Docker® Swarm, and Apache® Mesos utilize the cluster to streamline the deployment and management of container platform 210.

The containerized application may be a cloud-based application hosted on remote servers and accessed via the internet, rather than being installed locally on the user device 204. The application leverages cloud infrastructure to provide the scalability, flexibility, and cost-effectiveness. Users such as the user 218 can access features and data from anywhere, using various devices, which enhances collaboration and productivity. Examples include Software as a Service (Saas) applications like Google Workspace®, Salesforce®, and Dropbox®. Cloud applications automatically update, ensuring users have the latest features and security patches. They also benefit from cloud providers' robust security measures, data backup, and disaster recovery solutions, ensuring high availability and reliability.

In the container platform 210, the container object 214B1 corresponds to a running instance of the container 214B encapsulated within a pod. The pod is the smallest deployable unit in the container platform 210. Each Pod can host one or more tightly coupled containers that share same network namespace and storage. The container platform 210 such as the Kubernetes® manages the lifecycle of the container object 214B1, ensuring that the container object 214B1 is started, stopped, and restarted as needed to maintain the desired state of the container 214B. It also manages the scaling, resource management, and networking, allowing seamless communication between the containers. This orchestration enables efficient deployment and management of containerized applications in the container platform 210.

The set of admission controllers 212B are components of a container orchestration platform, such as a Kubernetes® API server, that govern how requests to create, update, or delete resources are processed. The set of admission controllers 212B acts as gatekeepers, allowing or denying requests, such as the request 208A, based on specific policies or rules before the resource is persisted in the cluster associated with the application. The set of admission controllers 212B may be categorized into two types. The two types may correspond to a validating admission controllers and a mutating admission controllers.

In an embodiment, the validating admission controllers evaluate incoming requests from the user 218 and can reject the request if the request 208A does not meet certain criteria. The validating admission controllers ensure that the requested changes comply with defined policies associated with the set of admission controllers 212B, such as security standards. The examples include, but are not limited to, PodSecurityPolicy and Open Policy Agent (OPA) Gatekeeper.

In an embodiment, the mutating admission controllers can modify the incoming requests before they are processed and scheduled to nodes. The mutating admission controllers can add or change fields in resource definition, enabling dynamic configuration. For instance, the mutating admission controller might automatically inject sidecar containers into Pods or set default resource limits. In an embodiment, the sidecar containers may provide additional functionalities, such as service discovery, logging, monitoring, or security features, without modifying the primary code of the application.

In an embodiment, the set of admission controllers 212B communicates directly with the SACM 208 running within the TEE 206 for response validation. In an alternate embodiment, the set of admission controllers 212B can send the response 208B to the request 208A to the SACM proxy 212C. By way of example, and not by limitation, the SACM proxy 212C may serve as an intermediary for the SACM 208. The SACM proxy 212C can handle the validation process, reducing the load on the SACM 208 and improving overall efficiency. By utilizing the SACM proxy 212C, the system 202 can streamline the operations while maintaining effective validation and compliance checks. This enhances scalability and responsiveness in managing operations of the set of admission controllers 212B.

The user device 204 includes suitable logic, circuitry, and/or interfaces that are configured to execute one or more tasks within the network environment 200. In an embodiment, the system 202 is configured to output an alert on the user device 204. The user device 204 is associated with the user 218. Examples of the user device 204 include one but are not limited to, a smartphone, a cellular phone, a mobile phone, a consumer electronic (CE) device, an Internet of Things (IoT) device, a computing device, a mainframe machine, a server, a computer workstation, or the like.

The kubelet 214A may correspond to an agent that establishes a connection between the control plane 212 and the data plane 214. In an embodiment, the kubelet 214A may be present within the data plane 214. The data plane 214 within the container platform 210 encompasses components responsible for executing application workloads. The data plane 214 includes worker nodes that run the pods, managed by the kubelet 214A, and utilize container runtimes like Docker® or Containerd®. Networking is facilitated through Container Network Interface (CNI) plugins, enabling communication between the pods and services. The kubelet 214A may be configured to interact with the set of admission controllers 212B to manage the execution of the container 214B. The kubelet 214A may be further configured to receive deployment response from the system 202 via the API server 212A. Based on the received deployment response, the kubelet 214A may be further configured to manage the lifecycle of pods such as scheduling the container for execution, updating container images, reporting container health status, and handling container failures or restarts.

In operation, to control the deployment of the container object 214B1 within the container platform 210, the system 202 is configured to intercept the response 208B to the request 208A associated with the deployment of the container object 214B1 within the container platform 210. In an embodiment, the response 208B is transmitted from the set of admission controllers 212B associated with the container platform 210. For example, the user 218 who may be the DevOps engineer may send the request 208A associated with the deployment of the container object 214B1 (such as Kubernetes® object) to the container platform 210. The API server associated with the container platform 210 receives the request 208A and authenticates the request 208A. Upon successful authentication of the request 208A by the API server, the request 208A is received by the set of admission controllers 212B associated with the container platform 210. In an exemplary embodiment, the user 218 may utilize a Command-Line Interface (CLI) to send the request 208A to the container platform 210. In an exemplary embodiment, the user 218 may utilize a web-based container platform dashboard, that may provide an interface to create and manage container object 214B1. In an exemplary embodiment, the user 218 may make a Hypertext Transfer Protocol (HTTP) request to the Application Programming Interface (API) server associated with the container platform 210 using tools such as, but not limited to, Curl® or Postman®. In an embodiment, the request 208A may be in a Yet Another Markup Language (YAML) format or JavaScript Object Notation (JSON) format. An example of the request in YAML format is provided below:

| apiVersion: apps/v1 | |
|---|---|
| kind: Deployment | |
| metadata: | |
| name: my-deployment | |
| namespace: default | |
| spec: | |
| replicas: 3 | |
| selector: | |
| matchLabels: | |
| app: my-app | |
| template: | |
| metadata: | |
| labels: | |
| app: my-app | |
| spec: | |
| containers: | |
| - | name: my-container |
| | image: nginx:latest |
| | ports: |
| | - containerPort: 80 |

The request 208A in YAML format provided above defines the container object 214B1 named “my-deployment” in “default” namespace, specifying that three replicas of the application should run. The “kind: Deployment” manages pods that contain a single container named “my-container,” which uses a latest version of the nginx image and exposes port 80. The selector ensures that the pods are labeled with “app: my-app” for proper management and scaling. Further, an example of request 208A in JSON format is provided below:

```
{
  “apiVersion”: “apps/v1”,
  “kind”: “Deployment”,
  “metadata”: {
    “name”: “my-deployment”,
    “namespace”: “default”
  },
  “spec”: {
    “replicas”: 3,
    “selector”: {
      “matchLabels”: {
        “app”: “my-app”
      }
    },
    “template”: {
      “metadata”: {
        “labels”: {
          “app”: “my-app”
        }
      },
      “spec”: {
        “containers”: [
          {
            “name”: “my-container”,
            “image”: “nginx:latest”,
            “ports”: [
              {
                “containerPort”: 80
              }
            ]
          }
        ]
      }
    }
  }
}
```

In an embodiment, the functionality of the JSON format is similar to the YAML format described above.

In an embodiment, the set of admission controllers 212B associated with the container platform 210 evaluates the request 208A based on defined policies before allowing the request 208A to proceed. The defined policies may be, for example, but are not limited to, the security policies, the resource quotas, labeling and annotation policies, image policies, namespace lifecycle policies, mutating policies, and validating policies. Upon evaluating the request 208A against the defined policies, the set of admission controllers 212B returns a response to the API server 212A. The response may correspond to one of a rejection of the request 208A or an allowance of the request 208A.

By way of example, and not by limitation, a malicious actor that may correspond to a hacker may alter the configuration of the set of admission controllers 212B, potentially compromising security and integrity of the container platform 210. The altered configuration by the malicious actor may allow harmful requests to bypass validation and mutation process, leading to the deployment of insecure or misconfigured resources within the application. In an exemplary embodiment, the malicious actor reroutes the request 208A from the set of admission controllers 212B to a private server associated with the malicious actor. The malicious actor tampers with the request 208A and sends the request 208A back to the API server associated with the container platform 210. Further, the system 202 intercepts the request 208A.

In an embodiment, upon intercepting the request 208A, the system 202 is configured to retrieve the one or more policies 208C from the set of defined policies based on the request 208A. In an embodiment, the system 202 is configured to retrieve the set of defined policies 216A from the one or more data sources 216. The one or more data sources 216 may correspond to a policy webhook that includes the set of defined policies 216A. In an embodiment, the system 202 is running within a trusted execution environment (TEE). The TEE is a secure area within a processor that ensures the confidentiality and integrity of code and data. Features of TEE are, for example, but are not limited to, isolation, confidentiality, and integrity. In an embodiment, container platforms utilize TEE to enhance security for containerized applications. Components associated with the TEE are, for example, but not limited to, a trusted computing base, an attestation service, and key management services. Further, the system 202 retrieves the one or more policies 208C. The one or more policies 208C are configured by an administrator of the system 202.

Further, the system 202 is configured to apply the one or more policies on the request 208A. The system 202 applies the one or more policies 208C against the request 208A intercepted from the set of admission controllers 212B. By applying the one or more policies 208C, the system 202 meticulously checks the request 208A for potential issues. This allows the system 202 to identify whether the set of admission controllers 212B is functioning properly. By evaluating the request 208A against the one or more policies 208C, the system 202 identifies anomalies or misconfigurations that may indicate a malfunction within the set of admission controllers 212B. This further ensures that the set of admission controllers 212B are effectively validating and mutating the request 208A as intended, thereby maintaining the overall security and integrity of the container platform 210.

Further, the system 202 is configured to determine the result of the application of the one or more policies 208C on the request 208A. In an embodiment, the result is indicative of the denial of the request 208A. In an alternate embodiment, the result is indicative of the allowance of the request 208A. In an embodiment, if the system 202 determines the result that indicates the allowance of the request 208A, then the determination indicates that the request 208A aligns with the one or more policies 208C. This further indicates that the request 208A follows the vital security protocols, validation rules, and operational standards. In this scenario, the system 202 allows the request 208A to proceed, ensuring that the request 208A does not introduce any vulnerabilities or issues within the container 214B hosted on the container platform 210. Further, the system 202 compares the determined result with the intercepted response 208B. In a scenario, if the intercepted response 208B generated by the set of admission controllers 212B corresponds to the allowance of the request 208A, then this indicates that the set of admission controllers 212B is functioning as intended, effectively mutating and validating received request 208A.

Further, if upon the application of the one or more policies 208C on the request 208A, the system 202 determines that the request 208A fails to comply with the one or more policies 208C, then the request 208A is classified as contradictory. The contradiction further signifies that there are issues with the request 208A, such as security risks, misconfigurations, wrongful mutation, or wrongful validation. When the contradiction is determined, the system 202 may take various actions, such as rejecting the request 208A, logging the incident for further analysis, or alerting administrators to investigate the underlying cause.

In an embodiment, upon the determination of the result, the system 202 is configured to identify an anomaly associated with the set of admission controllers 212B. Further, upon the identification of the anomaly associated with the set of admission controllers 212B, the system 202 is configured to control the deployment of the container object 214B1 within the container platform 210 based on the identified anomaly.

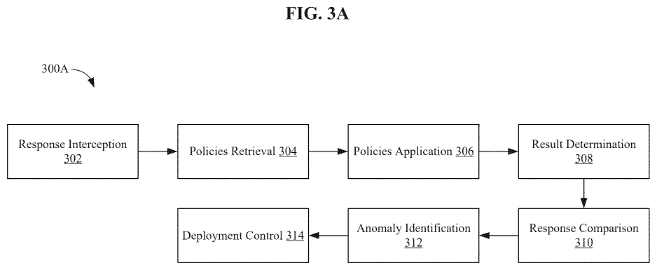

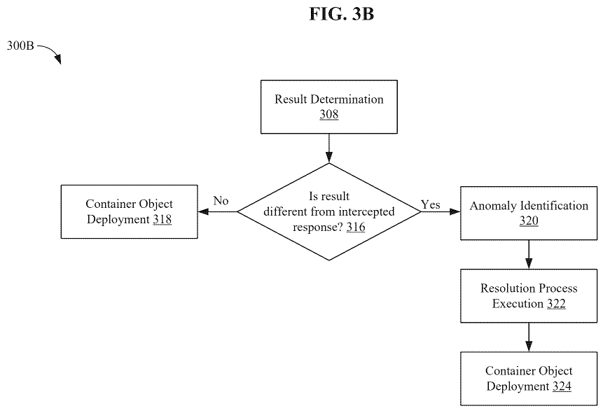

FIG. 3A is a block diagram 300A that illustrates one or more operations for controlling the deployment of the container object 214B1 within the container platform 210, in accordance with an embodiment of the disclosure. FIG. 3A is explained in conjunction with elements from FIG. 1, and FIG. 2

Traditionally, to deploy the container object 214B1 within the container platform 210, the user 218 (the DevOps engineer) sends the request 208A to deploy the container object 214B1. The request 208A is received by the API server 212A associated with the container platform 210. The API server 212A associated with the container platform 210 acts as a central management hub, facilitating communication between various components of the container platform 210. The API server 212A exposes a set of RESTful APIs that allow the user 218 and applications to interact with containerized services, manage resources, and orchestrate deployments. The API server 212A handles requests for creating, updating, and deleting containers. The API server 212A further monitors the status of the containers associated with the application hosted within the container platform 210. The API server 212A ensures security through authentication and authorization mechanisms, enabling controlled access to resources. The API server 212A simplifies integration with external tools and services by providing a standardized interface, enhancing the overall efficiency and scalability of containerized environments.

Further, upon the reception of the request 208A to deploy the container object 214B1, the API server 212A is controlled to execute an authentication operation on the received request 208A to generate an authenticated request. To authenticate the received request 208A, the API server 212A validates the request 208A against defined schemas and authorization rules. The schemas define structure and validation rules for the container object 214B1 that the API server 212A manages. The schemas ensure that the data sent to the API server 212A is according to expected formats. One or more components of schemas may be, but are not limited to, apiVersion, kind, metadata, spec, and status. The API server validates the request against these schemas to ensure data integrity.

In an embodiment, the apiversion specifies the API that is being used. Examples of the apiversion may be, but are not limited to, core API: ‘v1’, apps API group: ‘apps/v1’, batch API group: ‘batch/v1’, and networking API group: ‘networking.k8s.io/v1’. Further, the “kind” indicates the type of resource being defined (such as the cluster). Further, the metadata provides the vital information associated with the resource, such as name, namespace, labels, and annotations. The name corresponds to a string that represents the name of the resource. The name is unique within the namespace. The namespace corresponds to a string that specifies the namespace within which the resource resides. In a scenario, where the namespace is not specified, the resource is created with a default namespace. Further, the labels are key-value maps that may be used to organize and select resources.

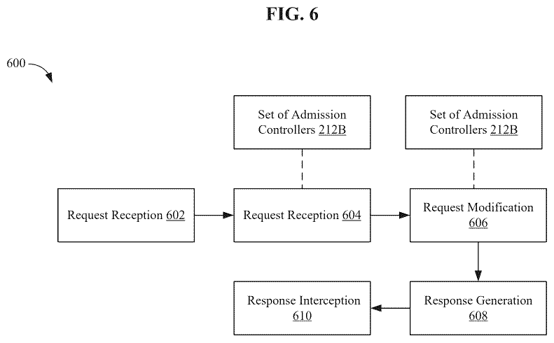

Upon successful authentication, the API server 212A sends the request 208A to the set of admission controllers 212B. The set of admission controllers 212B is configured to execute modification operation on the request 208A received from the API server 212A. Further, details about the modification operation executed by the set of admission controllers 212B are described in FIG. 6. Upon executing the modification operation, the set of admission controllers 212B generates the response 208B to the request 208A. By way of example, and not by limitation, the response 208B corresponds to an allowance of the request 208A or a denial of the request 208A.

At 302, a response interception operation is executed. In the request interception operation, the system 202 is configured to intercept the response 208B to the request 208A associated with the deployment of the container object 214B1 within the container platform 210. The response 208B is transmitted from the set of admission controllers 212B associated with the container platform 210.

By way of example, and not by limitation, the set of admission controllers 212B performs a validation operation and a mutation operation on the request 208A received from the API server 212A associated with the container platform 210. For example, the user 218 (that may be the DevOps engineer) submits the request 208A which corresponds to the deployment of the container object 214B1. The request 208A may be in YAML format as shown below:

| apiVersion: apps/v1 | |
|---|---|
| kind: Deployment | |
| metadata: | |
| name: my-app | |
| spec: | |
| replicas: 3 | |
| selector: | |
| matchLabels: | |
| app: my-app | |
| template: | |
| metadata: | |
| labels: | |
| app: my-app | |
| spec: | |
| containers: | |
| - | name: my-container |
| | image: my-image:latest |
| | resources: |
| | requests: |
| | cpu: “500m” |
| | memory: “256Mi” |

Further, the set of admission controllers 212B validates the request 208A by verifying the request 208A against the defined policies associated with the set of admission controllers 212B. For example, the set of admission controllers 212B checks that the number of replicas is within an acceptable range as defined by the defined policies. In a scenario, the pre-defined policy indicates that the number of replicas may lie in a range of 1 to 5. If the set of admission controllers 212B determines that the “replicas: 3”, the set of admission controllers 212B will allow the request 208A to persist. In a scenario, if the set of admission controllers 212B determines that the “replicas: 6”, the set of admission controllers 212B will reject the request 208A.

In an embodiment, upon successful execution of the validation process on the request 208A, the set of admission controllers 212B may mutate the request 208A to add default values or modify existing configurations within the request 208A. In an embodiment, the set of admission controllers 212B may add an annotation for monitoring purposes. The annotations are key-value pairs that can be attached to the container object 214B1 (such as Pods, Deployments, Services, etc.) to provide additional metadata. Further, monitoring is the practice of observing the performance, health, and behavior of the application and the infrastructure running within the cluster. The monitoring involves collecting metrics, logs, and events to gain insights into operation of the application. Upon automatically adding the annotation for monitoring, the mutated request 208A may be, for example, as shown below:

```
apiVersion: apps/v1
kind: Deployment
metadata:
  name: my-app
  annotations:
    monitoring.example.com/enabled: “true” (Added by the set of admission controller)
spec:
  replicas: 3
  selector:
    matchLabels:
      app: my-app
  template:
    metadata:
      labels:
        app: my-app
    spec:
      containers:
```

| | |
|---|---|
| - | name: my-container |
| | image: my-image:latest |
| | resources: |
| | requests: |
| | cpu: “500m” |
| | memory: “256Mi” |

Further, once the set of admission controllers 212B executes the validation operation and the mutation operation, the set of admission controllers 212B transmits the response 208B back to the API server 212A. While the set of admission controllers 212B is transmitting the response 208B to the API server 212A, the system 202 is configured to intercept the response 208B.

At 304, a policies retrieval operation is executed. In the policies retrieval operation the system 202 is configured to retrieve the one or more policies 208C from the set of defined policies based on the received request. In an embodiment, the system 202 is configured to retrieve the set of defined policies associated with the container platform 210. The set of defined policies may be retrieved from a policy webhook containing the defined policies. In an embodiment, the policy webhook that includes the defined policies may be created by the administrator of the system 202.

By way of example, and not by limitation, the request 208A is validated by the set of admission controllers 212B. In an embodiment, the defined policies include one or more policies 208C associated with the validation of the request 208A and one or more policies 208C associated with the mutation of the request 208A. As the request 208A is validated by the set of admission controllers 212B, the system 202 is configured to retrieve the one or more policies 208C associated with the validation of the request 208A. Upon the retrieval of the one or more policies 208C, the control may pass to 306.

At 306, a policies application operation is executed. In the policies application operation, the system 202 is configured to apply the one or more policies 208C on the request 208A. By way of example, and not by limitation, the system 202 applies the retrieved one or more policies 208C associated with the validation of the request 208A on the request 208A. For example, the defined policy associated with the set of admission controllers 212B indicates that the number of replicas allowed is in the range of 1 to 5. Further, the user 218 requested for deployment of the container object 214B1, and the field associated with the replica corresponds to “replica:6”. The set of admission controller 206A validated the request 208A. Further, once the system 202 intercepts the request 208A, the system 202 applies the one or more policies 208C associated with the validation of the request 208A on the request 208A. Upon the application of the one or more policies 208C associated with the validation of the request 208A, the control may pass to 308.

At 308, a result determination is executed. In the result determination operation, the system 202 is configured to determine the result of the application of the one or more policies 208C on the request 208A. In an embodiment, the result is indicative of the allowance of the request 208A. In an alternate embodiment, the result is indicative of the denial of the request 208A

By way of example, and not by limitation, as described in 306, the defined policy associated with the set of admission controllers 212B indicates that the number of replicas allowed is in the range of 1 to 5. Further, the user 218 requested for deployment of the container object 214B1, and the field associated with the replica corresponds to “replica: 6”. On applying the one or more policies 208C associated with the validation of the request 208A, the system 202 determines the result. Further, based on the application of the one or more policies 208C, the determined result indicates that the request 208A is to be denied. In an embodiment, the number of replicas is more than the specified range. The response 208B generated by the set of admission controllers 212B corresponds to the allowance of the request 208A. Further, upon the determination of the result, the system 202 is configured to compare the determined result with the intercepted response at 310.

At 310, a response comparison operation is executed. In the response comparison operation, the system 202 is configured to compare the intercepted response 208B with the determined result. In an embodiment, the comparison indicates that the determined result is different from the intercepted response. In an alternate embodiment, the comparison indicates that the determined result is identical to the intercepted response. By way of example, and not by limitation, the intercepted response 208B indicates that the set of admission controllers 212B allowed the request 208A to persist. Further, upon applying the one or more policies 208C on the request 208A, the system 202 determined the result. The result is indicative of the denial of the request. Further, the system 202 compares the intercepted response with the determined result. Upon the comparison, the system 202 determines that the determined result is different from the intercepted response 208B. The determination indicates that the set of admission controllers 212B is maliciously configured.

By way of example, and not by limitation, the intercepted response 208B indicates that the set of admission controllers 212B allowed the request 208A to persist. Further, upon applying the one or more policies 208C on the request 208A, the system 202 determined the result. The result is indicative of the allowance of the request. Further, the system 202 compares the intercepted response with the determined result. Upon the comparison, the system 202 determines that the determined result is identical to the intercepted response 208B. The determination indicates that the set of admission controllers 212B is working with the correct configurations. In a scenario, if the determined result is identical to the intercepted response, the system 202 is configured to control the deployment of the container object 214B1 within the container platform 210 based on the comparison. In a scenario, if the system 202 determines that the determined result is different from the intercepted response, the control may pass to 312 for identification of the anomaly associated with the set of admission controllers 212B.

At 312, an anomaly identification operation is executed. In the anomaly identification operation, the system 202 is configured to identify the anomaly associated with the set of admission controllers 212B based on the comparison. By way of example, and not by limitation, the system 202 determines that the anomaly persists within validation of the request 208A, the system 202 is configured to identify the anomaly associated with the set of admission controllers 212B. Upon the identification of the anomaly, the system 202 is configured to execute a resolution process. Details about the anomaly identification are provided in FIG. 3B.

At 314, a deployment control operation is executed. In the deployment control operation, the system 202 is configured to control the deployment of the container object 214B1 within the container platform 210 based on the identified anomaly.

FIG. 3B is a block diagram 300B that illustrates one or more operations executed based on a comparison of the determined result with the intercepted response 208B, in accordance with an embodiment of the disclosure. FIG. 3B is explained in conjunction with elements from FIG. 1, FIG. 2, and FIG. 3A.

In an embodiment, the system 202 is configured to execute the result determination operation. The details about the execution of the result determination operation are provided at 308 in FIG. 3A. Further, at 316, the system 202 is configured to compare the determined result with the intercepted response 208B to determine if the determined result is different from the intercepted response 208B. In an embodiment, based on the determined result not being different from the intercepted response 208B, the control may pass to 318.

At 318, a container object deployment operation is executed. In the container object deployment operation, the system 202 is configured to deploy the container object 214B1 within the container platform 210 based on the comparison of the determined result with the intercepted response 208B. In an embodiment, once the request 208A for creating the container object 214B1 has successfully passed through validation and mutation processes, the request 208A is ready to be persisted in the etcd. In an embodiment, the etcd is the distributed key-value store that serves as the primary data store for the container platform 210. The etcd is vital as the etcd maintains the desired state of the entire cluster, ensuring that configurations and resources are reliably stored and can be retrieved when needed. The API server 212A receives the validated request 208A from the system 202 and creates the container object 214B1 in the specified namespace, effectively making it part of the cluster's state. Further, once the container object 214B1 is stored, the container object 214B1 becomes accessible to various components within the container platform 210, such as, but not limited to controllers and schedulers. In an exemplary embodiment, the successful deployment of the container object 214B1 triggers the generation of events, which are logged for auditing and monitoring purposes, providing visibility into state changes within the cluster and facilitating troubleshooting and operational oversight.

Further, each event contains metadata, including the type of action performed (such as a creation of the container object 214B1, a deletion of the container object 214B1, or an update of the container object 214B1), and a timestamp at which the action is performed. This information is needed by the user 218, as it allows the user 218 to track changes, understand the sequence of operations, and identify any issues that may arise.

In an embodiment, if at 316, based on the comparison of the determined result with the intercepted response 208B, the system 202 determines that the determined result is different from the intercepted response 208B, the control may pass to 320.

At 320, an anomaly identification operation is executed. In the anomaly identification operation, the system 202 is configured to identify an anomaly associated with the set of admission controllers 212B based on the comparison. By way of example, and not by limitation, the user 218 submitted the request 208A to deploy the container object 214B1 to allocate extra memory for the application hosted on the container platform 210. The validating admission controller of the set of admission controllers 212B processed the request 208A and approved the request 208A. For example, the amount of memory that user 218 is eligible for corresponds to 8 gigabytes (GB). The amount of memory demanded by the user 218 in the request 208A corresponds to 16 GB. The malicious actor maliciously configured the validating admission controller, resulting in the response corresponding to the approval of the request 208A. Further, once the system 202 applies the one or more policies 208C on the request 208A, the system 202 determines that the request 208A is not validated correctly. Further, the system 202 identifies that, as the validation of the request 208A has not been done correctly, the anomaly lies within the validating admission controller. Further, upon the identification of the anomaly, the control may pass to 322.

At 322, a resolution process execution operation is executed. In the resolution process execution operation, the system 202 is configured to execute the resolution process to rectify the identified anomaly associated with the set of admission controllers. In an embodiment, the resolution process includes one of a deletion of a first admission controller of the set of admission controllers 212B associated with the container platform 210 or a creation of the first admission controller of the set of admission controllers 212B associated with the container platform 210.

By way of example, and not by limitation, the system 202 is configured to assess the state of the validating admission controller of the set of admission controllers 212B. In an embodiment, the system 202 analyzes the configuration settings of the validating admission controller and identifies specific parameters that were manipulated by the malicious actor. This assessment helps in understanding the root cause of the anomaly. Based on the assessment, the system 202 determines the most effective method to rectify the anomaly. The resolution process may involve one of the deletion of the admission controller or the creation of the admission controller. In an exemplary embodiment, the admission controller corresponds to the validating admission controller. For example, if the validating admission controller is compromised, the system 202 may be configured to delete the admission controller entirely. This would prevent any further request 208A from being processed by the compromised validating admission controller.

Further, the system 202 may be configured to create a new admission controller within the control plane 212, where the new admission controller corresponds to a new validating admission controller with the correct configurations and policies. The new admission controller would replace the admission controller, ensuring that future requests are validated correctly according to established resource limits and security policies.

In an embodiment, once the resolution process is complete, the system 202 may revalidate request 208A that was intercepted during the anomaly identification. This ensures that requests are processed under the new, secure validating admission controller, maintaining the integrity of resource allocation. Further, upon successful completion of the resolution process, the control may pass to 324.

At 324, a container object deployment operation is executed. In an embodiment, the system 202 is configured to execute the container object deployment operation similar to the container object deployment operation described in 314.

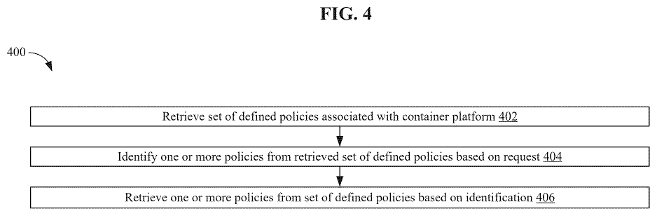

FIG. 4 is a flowchart 400 that illustrates retrieval of the one or more policies 208C, in accordance with an embodiment of the disclosure. FIG. 3B is explained in conjunction with elements from FIG. 1, FIG. 2, FIG. 3A, and FIG. 3B.

At 402, the system 202 is configured to retrieve the set of defined policies associated with the container platform 210. In an embodiment, the defined policies may be in the policy webhook which is a user-defined Hypertext Transfer Protocol (HTTP) callback that allows an application to send real-time data upon occurrence of an event. In an embodiment, the policy webhook is associated with the container platform 210. The policy webhook includes a set of defined policies that monitor the health and functionality of the set of admission controllers 212B. The set of defined policies verifies that the set of admission controllers 212B is operating correctly, identifying any malfunctions or misconfigurations that could impact the security and integrity of the container platform 210.

In an embodiment, the policy webhook is associated with the container platform 210 and encompasses the set of defined policies 216A. The set of defined policies 216A is specifically configured by the administrator of the system 202 to monitor the health and functionality of the set of admission controllers 212B. The set of defined policies 216A within the policy webhook systematically verifies that the set of admission controllers 212B is functioning correctly, ensuring that the set of admission controllers 212B validates and mutates the request 208A as intended. By continuously monitoring the performance of the set of admission controllers 212B, the system 202 identifies malfunctions or misconfigurations that may arise. The proactive monitoring is vital for safeguarding the security and integrity of the container platform 210, as it helps prevent potential vulnerabilities that could be exploited by malicious actors or lead to operational disruptions.

At 404, the system 202 is configured to identify the one or more policies from the set of defined policies 216A based on the request 208A. In an exemplary embodiment, the system 202 intercepts the request 208A from the set of admission controllers 212B and analyzes the request 208A to determine whether the request 208A is validated, mutated, or both. Based on the determination, the system 202 is configured to identify one or more policies 208C from the set of defined policies. In a scenario, the set of admission controllers 212B performed the validation operation on the request 208A, the system 202 is configured to identify the one or more policies 208C associated with the validation of the request 208A from the set of defined policies 216A. In a scenario, the set of admission controllers 212B performed the mutation operation on the request 208A, the system 202 is configured to identify the one or more policies 208C associated with the mutation of the request 208A from the set of defined policies 216A. In a scenario, the set of admission controllers 212B performed both (the validation operation and the mutation operation) on the request 208A, the system 202 is configured to identify the one or more policies 208C associated with the validation of the request 208A and the one or more policies 208C associated with the mutation of the request 208A from the set of defined policies 216A. Further, upon the identification of the one or more policies 208C, the control may pass to 406

At 406, the system 202 is configured to retrieve the one or more policies 208C from the set of defined policies 216A based on the identification. For instance, if the system 202 identifies that the request 208A is been validated by the set of admission controllers 212B, then the system 202 is configured to retrieve the one or more policies 208C policies associated with the validation of the request 208A from the set of defined policies 216A. Similarly, if the system 202 identifies that the request 208A is mutated by the set of admission controllers 212B, then the system 202 is configured to retrieve the one or more policies 208C associated with the mutation of the request 208A from the set of defined policies 216A. Further, in a scenario, if the system 202 identifies that the set of admission controllers 212B performed both the validation operation and the mutation operation on the request 208A, then the system 202 is configured to retrieve the one or more policies 208C associated with the validation of the request 208A and the one or more policies 208C associated with the mutation of the request 208A from the set of defined policies 216A.

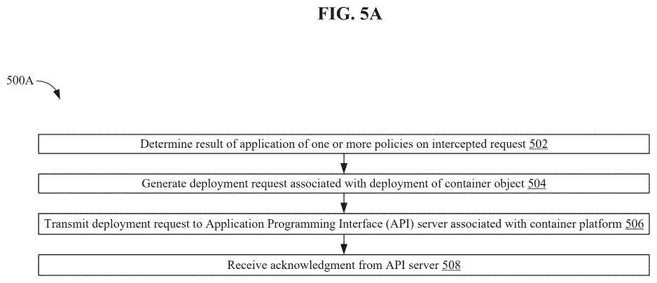

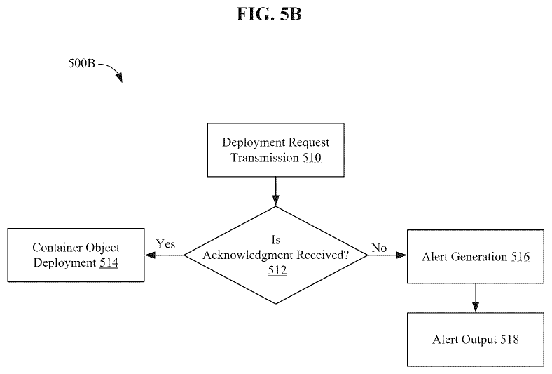

FIG. 5A is a flowchart 500A that illustrates a reception of acknowledgment from the API server associated with the container platform 210, in accordance with an embodiment of the disclosure. FIG. 5A is explained in conjunction with elements from FIG. 1, FIG. 2, FIG. 3A, FIG. 3B, and FIG. 4.

At 502, the system 202 is configured to determine the result of the application of the one or more policies 208C on the request 208A. In an embodiment, the result is indicative of the denial of the request 208A. In an alternate embodiment, the result is indicative of allowance of the request 208A. By way of example, and not by limitation, the one or more policies 208C are utilized to determine that the set of admission controllers 212B associated with the container platform 210 are functioning efficiently. The efficient functioning of the set of admission controllers 212B indicates that the set of admission controllers 212B such as the validating admission controller or the mutating admission controller are functioning correctly.

By way of example, and not by limitation, the container platform 210 includes a first application associated with a first user, a second application associated with a second user, and a third application associated with a third user. The first application, the second application, and the third application are deployed within the cluster associated with the container platform 210. The first user associated with the first application initiates a first request associated with the deployment of the container object 214B1 requesting, for example, 12 Central Processing Unit (CPU) cores for running the first application. In an example, a CPU limit associated with the first application corresponds to 10 CPUs. An example of the first request initiated by the first user is provided below.

```
apiVersion: v1
kind: ResourceQuota
metadata:
  name: example-quota
  namespace: first application
spec:
  hard:
    requests.cpu: “12”
    limits.cpu: “10”
```

The “kind: ResourceQuota” indicates that the policy that is being applied corresponds to the resource quota policy that limits the amount of CPU resources that can be utilized by the first application. The set of admission controllers 212B receives the first request associated with the first application and validates the first request. Further, the set of admission controllers 212B transmits the first request back to the API server associated with the container platform 210.

The system 202 intercepts the response 208B to the first request transmitted from the set of admission controllers 212B associated with the container platform 210. Upon intercepting the response 208B to the first request, the system 202 retrieves a first policy from the set of defined policies 216A based on the first request. The first policy of the one or more policies 208C corresponds to the resource quotas policy. Further, the system 202 applies the resource quota policy on the first request. For example, the resource quota policy indicates that the amount of CPU resources that can be utilized by the first application corresponds to 10 CPUs, but the set of admission controllers 212B validated the first request that requested 12 CPUs. This indicates that the validating admission controller that is responsible for validating the first request is maliciously misconfigured. By applying the first policy on the first request, the system 202 determines the result. The result indicates that the first request is invalid and is to be denied but the set of admission controllers 212B validated the first request. In an embodiment, the system 202 is configured to generate a notification on the user device associated with the first user indicating the rejection of the first request.

Further, upon the determination of the result, the system 202 is configured to identify the anomaly. The system 202 identifies that the anomaly lies within the validating admission controller as the validating admission controller validated the first request incorrectly, Further, upon the identification of the anomaly, the system 202 executes the resolution process to rectify the identified anomaly. The rectification process corresponds to the deletion of the compromised validating admission controller and the creation of a new validating admission controller.

By way of example, and not by limitation, upon the execution of the resolution process, the system 202 intercepts the response 208B to the second request associated with the second application. The second request is initiated by the second user. In an example, the second user associated with the second application initiates the second request associated with the deployment of the container object 214B1 requesting, for example, 9 Central Processing Unit (CPU) cores for running the second application. In an example, a CPU limit associated with the second application corresponds to 10 CPUs. An example of the first request initiated by the second user is provided below.

```
apiVersion: v1
kind: ResourceQuota
metadata:
  name: example-quota
  namespace: second application
spec:
  hard:
    requests.cpu: “9”
    limits.cpu: “10”
```

Upon intercepting the response to the second request, the system 202 retrieves the first policy from the set of defined policies 216A based on the second request. The first policy of the one or more policies 208C corresponds to the resource quotas policy. Further, the system 202 applies the resource quota policy on the second request. For example, the resource quota policy indicates that the amount of CPU resources that can be utilized by the second application corresponds to 10 CPUs. The set of admission controllers 212B validated the second request that requested 9 CPUs. This indicates that the validating admission controller that is responsible for validating the second request is operating as intended. By applying the first policy on the second request, the system 202 determines the result that indicates to allowance of the second request. Based on the determined result corresponding to the allowance of the second request, the control may pass to 504

At 504, the system 202 is configured to generate a deployment request associated with the deployment of the container object 214B1 within the container platform 210. For example, once the system 202 determines that the set of admission controllers 212B performed the validation operation successfully, the system 202 is configured to generate the deployment request associated with the deployment of the container object 214B1 within the container platform 210. For instance, as described at 502, the second user submits the second request requesting 9 CPU cores for the second application, and the defined resource limit for the second application corresponds to 10 CPU cores, the system 202 determines that the requested resources fall within allowable limits. Consequently, the deployment request is created, encapsulating specifications for the desired state of the second application, including container images, resource requests, replicas, and labels or annotations. An example of the generated deployment request is provided below:

| apiVersion: apps/v1 | |
|---|---|
| kind: Deployment | |
| metadata: | |
| name: example-deployment | |
| namespace: default | |
| spec: | |
| replicas: 2 | |
| selector: | |
| matchLabels: | |
| app: example-app | |
| template: | |
| metadata: | |
| labels: | |
| app: example-app | |
| spec: | |
| containers: | |
| - | name: example-container |
| | image: example-image:latest |
| | resources: |
| | requests: |
| | cpu: “9” |
| | limits: |
| | cpu: “10” |

Further, upon the generation of the deployment request, the control may pass to 506.

At 506, the system 202 is configured to transmit the deployment request to the API server associated with the container platform. By way of example, and not by limitation, The system 202 is configured to transmit the generated deployment request to the API server 212A associated with the container platform 210, facilitating the deployment of the container object 214B1. The system 202 is configured to transmit the deployment request over a secure HTTP connection. The HTTP connection is a protocol used for transmitting data over the web, enabling communication between clients and servers. The HTTP connection operates on a request-response model, where a client (the system 202) sends the request to the server (the API server 212A associated with the container platform 210), which then processes the request and returns an acknowledgment. Upon the transmission of the deployment request, the control may pass to 508.

At 508, the system 202 is configured to receive an acknowledgment from the API server. The acknowledgment is indicative of the reception of the deployment request by the API server. By way of example, and not by limitation, the system 202 receives the acknowledgment from the API server through the response to the deployment request. The acknowledgment may be in the JSON format. The acknowledgment ensures that the deployment request is confirmed by the API server associated with the container platform 210, providing feedback on the status of the request. The acknowledgment may include, for example, but not limited to, timestamp or request ID to manage tracking and debugging. An example of the acknowledgment is provided below:

```
{
  “status”: “success”,
  “requestId”: “12345”,
  “message”: “Deployment request received and is being processed.”,
  “timestamp”: “2024-12-28T12:00:00Z”
}
```

FIG. 5B is a block diagram 500B that illustrates a generation of an alert based on the reception of the acknowledgment, in accordance with an embodiment of the disclosure. FIG. 5B is explained in conjunction with elements from FIG. 1, FIG. 2, FIG. 3A, FIG. 3B, FIG. 4, and FIG. 5A.

At 510, the system 202 is configured to execute a deployment request transmission operation. In the deployment request transmission operation, the system 202 is configured to transmit the deployment request associated with the deployment of the container object 214B1 to the API server associated with the container platform 210. In an embodiment, the process of transmitting the deployment request to the API server associated with the container platform 210 is described in FIG. 5A. Further, upon the transmission of the deployment request to the API server, the control may pass to 512.

At 512, the system 202 is configured to determine if the acknowledgment associated with the transmission of the deployment request is received from the API server. The details about the reception of the acknowledgment associated with the transmission of the deployment request are provided in FIG. 5A. In an embodiment, if the system 202 determines that the acknowledgment associated with the transmission of the deployment request is received, the control may pass to 514.

At 514, the container object deployment operation is executed. In the container object deployment operation, the system 202 is configured to deploy the container object 214B1 within the container platform 210. In an embodiment, the container object deployment operation 514 is similar to the container object deployment operation 314 described in FIG. 3B. Further, if at 512, the system 202 determines that the acknowledgment associated with the transmission of the deployment request is not received, the control may pass to 516.

At 516, an alert generation operation is executed. In the alert generation operation, the system 202 is configured to generate an alert based on the reception of the acknowledgment. By way of example, and not by limitation, the system 202 transmits the deployment request associated with the deployment of the container object within the second application associated with the container platform 210. Further, due to one or more reasons, the system 202 failed to receive the acknowledgment associated with the transmission of the deployment request. The one or more reasons may be, but are not limited to, network issues, API server overload, timeouts, or API server errors. In a scenario, if the system 202 fails to receive the acknowledgment due to one or more reasons, the system 202 generates the alert indicative of an audit event. The audit event may ensure that potential issues, due to which the acknowledgment is not received are promptly addressed. An example of the generated alert is provided below:

```
{
  “eventType”: “Audit Alert”,
  “timestamp”: “2024-12-28T12:05:00Z”,
  “severity”: “High”,
  “message”: “No acknowledgment received from API server for deployment request.”,
  “requestId”: “12345”,
  “suggestedAction”: “Investigate network connectivity and server status.”
}
```

Further, upon the generation of the alert based on the reception of the acknowledgment, the control may pass to 518.

At 518, an alert output operation is executed. In the alert output operation, the system 202 is configured to output the generated alert on the user device 204. By way of example, and not by limitation, if the acknowledgment associated with the transmission of the deployment request associated with the deployment of the container object within the second application is not received, the system 202 generates the alert and outputs the alert on the user device 204 associated with the second user. The system 202 further outputs the generated alert on the user device associated with the administrator of the cluster, where the second application is hosted.

FIG. 6 is a block diagram 600 that illustrates a modification of the request 208A by the set of admission controllers 212B, in accordance with an embodiment of the disclosure. FIG. 6 is explained in conjunction with elements from FIG. 1, FIG. 2, FIG. 3A, FIG. 3B, FIG. 4, FIG. 5A, and FIG. 5B.

At 602, a request reception operation is executed. In the request reception operation, the system 202 is configured to control the API server 212A to receive the request 208A associated with the deployment of the container object 214B1 within the container platform 210. In an embodiment, the request 208A is initiated by the user 218 (the DevOps engineer). The API server 212A authenticates the received request 208A. By way of example, and not by limitation, the user 218 initiates the process for the deployment of the container object 214B1 by sending the request 208A from the user device 204 associated with the user 218 to the container platform 210. The request 208A is received by the API server 212A associated with the container platform 210 for authentication. The API server 212A performs validation of the request 208A by checking the source of the request 208A against a list of authenticated users and services. The API server 212A verifies whether the request 208A originates from a legitimate and authorized source, ensuring that only authenticated users can initiate deployments of the container object 214B1. In a scenario, if the request 208A is authenticated successfully, the API server 212A transmits the request 208A to the set of admission controllers 212B. In a scenario, if the request 208A is not authenticated successfully, the AI server 212A rejects the request 208A, thereby safeguarding the container platform 210. Further, in a scenario where the request 208A is authenticated successfully, the control may pass to 604.

At 604, a request reception operation is executed. In the request reception operation, the system 202 is configured to control the set of admission controllers to receive the request 208A from the API server 212A associated with the container platform 210. In an embodiment, the set of admission controllers 212B is configured to perform a modification operation on the received request 208A to modify the received request 208A. By way of example, and not by limitation, the set of admission controllers 212B receives the request 208A from the API server 212A associated with the container platform 210 during the request reception operation. Upon the successful reception of the request 208A, the control may pass to 606.

At 606, a request modification operation is executed. In the request modification operation, the system 202 is configured to control the set of admission controllers 212B to modify the received request 208A. By way of example, and not by limitation, upon receiving the request 208A, the set of admission controllers 212B performs the modification operation. In an embodiment, the modification operation may include the validation operation and the mutation operation. At a first timestamp, the validating admission controller of the set of admission controllers 212B performs the validation operation on the received request 208A to ensure that the request 208A adheres to the defined policies associated with the set of admission controllers 212B. During the validation operation, the validating admission controller checks for compliance with the resource quotas, and the image security policies, confirming that the request 208A is legitimate and safe to process. Further, upon the execution of the validation operation, the mutating admission controller executes the mutation operation on the received request 208A at a second timestamp. The mutation operation may include modifying specific parameters, such as adjusting resource limits or adding vital labels and annotations to the request. Further, upon the execution of the modification operation, the control may pass to 608.

At 608, a response generation operation is executed. In the response generation operation, the system 202 is configured to control the set of admission controllers to generate the response 208B to the modified request. In an embodiment, the response 208B corresponds to the allowance of the modified request. In an alternate embodiment, the response 208B corresponds to the denial of the modified request.

At 610, a response interception operation is executed. In the response interception operation, the system 202 is configured to intercept the response to the modified request 208A associated with the deployment of the container object 214B1 within the container platform 210. In an embodiment, the response associated with the modified request is transmitted from the set of admission controllers 212B. Further, once the set of admission controllers 212B transmit the response 208B of the modified request to the API server 212A, the system 202 is configured to intercept the response 208B to the modified request. In an embodiment, the response interception operation 610 is similar to the response interception operation described in FIG. 3A.

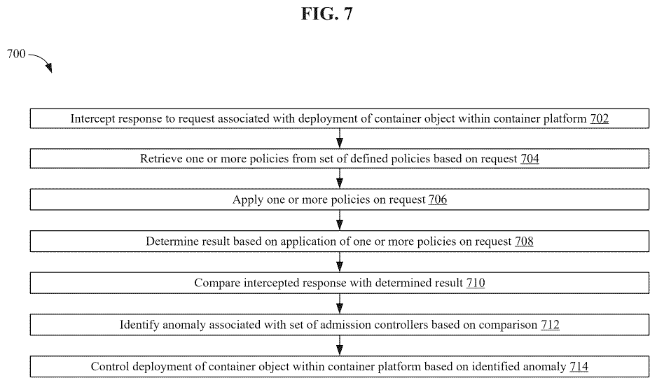

FIG. 7 illustrates a flowchart 700 of a first exemplary method for controlling the deployment of the container object 214B1 within the container platform 210, in accordance with an embodiment of the disclosure. FIG. 7 is explained in conjunction with elements of FIG. 1, FIG. 2, FIG. 3A, FIG. 3B, FIG. 4, FIG. 5A, FIG. 5B, and FIG. 6. With reference to FIG. 7, there is shown the flowchart 700. The operations of the exemplary method may be executed by any computing system, for example, by the computer 102 of FIG. 1 or the system 202 of FIG. 2. The operations of the flowchart 700 may start at 702.

At 702, the response 208B to the request 208A associated with the deployment of the container object 214B1 within the container platform 210 is intercepted. The response 208B is transmitted from the set of admission controllers 212B associated with the container platform 210. In an embodiment, the system 202 is configured to intercept the response 208B to the request 208A associated with the deployment of the container object 214B1 within the container platform 210. The response 208B is transmitted from the set of admission controllers 212B associated with the container platform 210.

At 704, the one or more policies 208C are retrieved from the set of defined policies 216A based on the request 208A. In an embodiment, the system 202 is configured to retrieve the one or more policies 208C from the set of defined policies 216A based on the request 208A.

At 706, the one or more policies 208C are applied on the request 208A. In an embodiment, the system 202 is configured to apply the one or more policies 208C on the request 208A.

At 708, the result is determined based on the application of the one or more policies 208C on the request 208A. The result is indicative of the denial of the request 208A. In an embodiment, the system 202 is configured to determine the result of application of the one or more policies 208C on the request 208A. The result is indicative of the denial of the request 208A.

At 710, the intercepted response 208B is compared with the determined result. The comparison indicates that the determined result is different from the intercepted response. In an embodiment, the system 202 is configured to compare the intercepted response 208B with the determined result. The comparison indicates that the determined result is different from the intercepted response.

At 712, the anomaly associated with the set of admission controllers 212B is identified based on the comparison. In an embodiment, the system 202 is configured to identify the anomaly associated with the set of admission controllers 212B based on the comparison.

At 714, the deployment of the container object 214B1 within the container platform 210 is controlled based on the identified anomaly. In an embodiment, the system 202 is configured to control the deployment of the container object 214B1 within the container platform 210.

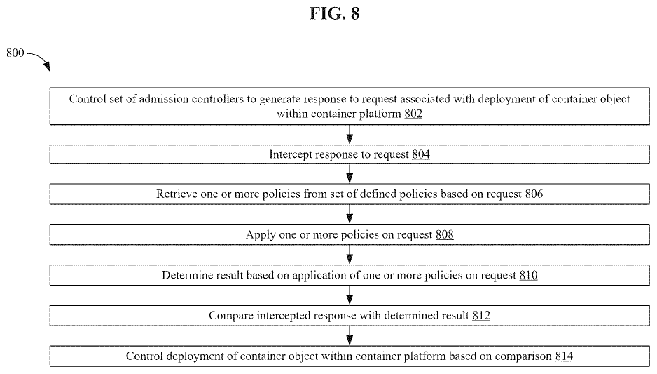

FIG. 8 illustrates a flowchart 800 of a second exemplary method for controlling the deployment of the container object 214B1 within the container platform 210, in accordance with an embodiment of the disclosure. FIG. 8 is explained in conjunction with elements of FIG. 1, FIG. 2, FIG. 3A, FIG. 3B, FIG. 4, FIG. 5A, FIG. 5B, FIG. 6, and FIG. 7. With reference to FIG. 8, there is shown the flowchart 800. The operations of the exemplary method may be executed by any computing system, for example, by the computer 102 of FIG. 1 or the system 202 of FIG. 2. The operations of the flowchart 800 may start at 802.

At 802, the set of admission controllers 212B is controlled to generate the response 208B to the request 208A associated with the deployment of the container object 214B1 within the container platform 210. The set of admission controllers 212B receives the request 208A from the API server 212A. In an embodiment, the system 202 is configured to control the set of admission controllers 212B to generate the response 208B to the request 208A associated with the deployment of the container object 214B1 within the container platform 210. The set of admission controllers 212B receives the request 208A from the API server 212A.

At 804, the response 208B to the request 208A is intercepted. The response 208B is transmitted from the set of admission controllers 212B associated with the container platform 210. In an embodiment, the system 202 is configured to intercept the response 208B to the request 208A. The response 208B is transmitted from the set of admission controllers 212B associated with the container platform 210.

At 806, the one or more policies 208C are retrieved from the set of defined policies 216A based on the request 208A. In an embodiment, the system 202 is configured to retrieve the one or more policies 208C from the set of defined policies 216A based on the request 208A.

At 808, the one or more policies 208C are applied on the request 208A. In an embodiment, the system 202 is configured to apply the one or more policies 208C on the request 208A.

At 810, the result based on the application of the one or more policies 208C on the request 208A is determined. The result is indicative of an allowance of the request. In an embodiment, the system 202 is configured to determine the result based on the application of the one or more policies 208C on the request 208A. The result is indicative of an allowance of the request.

At 812, the intercepted response 208B is compared with the determined result. The comparison indicates that the determined result is identical to the intercepted response 208B. In an embodiment, the system 202 is configured to compare the intercepted response 208B with the determined result. The comparison indicates that the determined result is identical to the intercepted response 208B.

At 814, the deployment of the container object 214B1 within the container platform 210 is controlled based on the comparison. In an embodiment, the system 202 is configured to control the deployment of the container object 214B1 within the container platform 210 based on the comparison.

In various embodiments of the disclosure, a computer program product for controlling the deployment of the container object within the container platform is described. The computer program product includes a computer-readable storage media having program instructions stored on the computer-readable storage media to perform operations. The operations include intercepting the response to the request associated with the deployment of the container object within the container platform. The request is transmitted from a set of admission controllers associated with the container platform. The operations further include retrieving one or more policies from a set of defined policies based on the request. The operations further include applying the one or more policies on the request. The operations further include determining a result based on the application of the one or more policies on the request. The result is indicative of the denial of the request. The operations further include comparing the intercepted response with the determined result. The comparison indicates that the determined result is different from the intercepted response. The operations further include controlling the deployment of the container object within the container platform based on the comparison.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A computer-implemented method comprising:
intercepting, by a computer, a response to a request associated with a deployment of a container object within a container platform, wherein the response is transmitted from a set of admission controllers associated with the container platform;
retrieving, by the computer, one or more policies from a set of defined policies based on the request;
applying, by the computer, the one or more policies on the request;
determining, by the computer, a result based on the application of the one or more policies on the request, wherein the result is indicative of a denial of the request;
comparing, by the computer, the intercepted response with the determined result, wherein the comparison indicates that the determined result is different from the intercepted response;
identifying, by the computer, an anomaly associated with the set of admission controllers based on the comparison; and
controlling, by the computer, the deployment of the container object within the container platform based on the identified anomaly.

2. The computer-implemented method of claim 1, further comprising:
retrieving, by the computer, the set of defined policies associated with the container platform;
identifying, by the computer, the one or more policies from the retrieved set of defined policies based on the request; and
retrieving, by the computer, the one or more policies from the set of defined policies based on the identification.

3. The computer-implemented method of claim 1, further comprising:
identifying, by the computer, the determined result is different from the intercepted response, wherein the identification is based on the comparison of the intercepted response with the determined result;
identifying, by the computer, the anomaly associated with the set of admission controllers based on the identification that the determined result is different from the intercepted response;
executing, by the computer, a resolution process to rectify the identified anomaly associated with the set of admission controllers; and
deploying, by the computer, the container object within the container platform based on the execution of the resolution process.

4. The computer-implemented method of claim 3, wherein the resolution process comprises one of a deletion of an admission controller of the set of admission controllers associated with the container platform or a creation of the admission controller of the set of admission controllers associated with the container platform.

5. The computer-implemented method of claim 3, further comprising:
generating, by the computer, a deployment request associated with the deployment of the container object within the container platform;
transmitting, by the computer, the deployment request to an Application Programming Interface (API) server associated with the container platform; and
receiving, by the computer, an acknowledgment from the API server, wherein the acknowledgment is indicative of a reception of the deployment request by the API server.

6. The computer-implemented method of claim 5, further comprising:
generating, by the computer, an alert based on the reception of the acknowledgment; and
outputting, by the computer, the generated alert on a user device.

7. The computer-implemented method of claim 1, further comprising:
controlling, by the computer, an Application Programming Interface (API) server associated with the container platform to receive the request associated with the deployment of the container object within the container platform;
controlling, by the computer, the API server to execute an authentication operation on the received request to generate an authenticated request; and
controlling, by the computer, the API server to transmit the authenticated request to the set of admission controllers.

8. The computer-implemented method of claim 7, further comprising:
controlling, by the computer, the set of admission controllers to receive the authenticated request transmitted from the API server;
controlling, by the computer, the set of admission controllers to execute a modification operation on the authenticated request, wherein the modification operation is executed to generate a modified request;
controlling, by the computer, the set of admission controllers to generate the response to the modified request, wherein the response corresponds to an allowance of the modified request; and
intercepting, by the computer, the response associated with the modified request.

9. The computer-implemented method of claim 8, wherein the modification operation corresponds to one of a validation operation or a mutation operation, wherein the validation operation corresponds to a determination that the authenticated request is based on the one or more policies of the set of defined policies, and wherein the mutation operation corresponds to a mutation of the authenticated request.

10. A computer system comprising:
a processor set;
one or more computer-readable storage media; and
program instructions stored on the one or more computer-readable storage media, the program instructions executable by the processor set to cause the processor set to:
control a set of admission controllers to generate a response to a request associated with a deployment of a container object within a container platform, wherein the set of admission controllers receives the request from an Application Programming Interface (API) server;
intercept the response to the request, wherein the response is transmitted from the set of admission controllers associated with the container platform;
retrieve one or more policies from a set of defined policies based on the request;
apply the one or more policies on the request;
determine a result based on the application of the one or more policies on the request, wherein the result is indicative of an allowance of the request;
compare the intercepted response with the determined result, wherein the comparison indicates that the determined result is identical to the intercepted response; and
control the deployment of the container object within the container platform based on the comparison.

11. The computer system of claim 10, wherein the program instructions further cause the processor set to:
control the API server associated with the container platform to receive the request associated with the deployment of the container object within the container platform, wherein the request is received by the API server for an authentication of the request;
control the API server to execute an authentication operation on the received request to generate an authenticated request; and
control the API server to transmit the authenticated request to the set of admission controllers.

12. The computer system of claim 11, wherein the program instructions further cause the processor set to:
control the set of admission controllers to receive the authenticated request transmitted from the API server;
control the set of admission controllers to execute a modification operation on the authenticated request, wherein the modification operation is executed to generate a modified request; and
control the set of admission controllers to generate the response to the modified request, wherein the response corresponds to an allowance of the modified request.

13. The computer system of claim 12, wherein the modification operation corresponds to one of a validation operation or a mutation operation, wherein the validation operation corresponds to a determination that the authenticated request is based on the one or more policies of the set of defined policies, and wherein the mutation operation corresponds to a mutation of the authenticated request.

14. The computer system of claim 11, wherein the program instructions further cause the processor set to:
retrieve the set of defined policies associated with the container platform;
identify the one or more policies from the retrieved set of defined policies based on the request; and
retrieve the one or more policies from the set of defined policies based on the identification.

15. The computer system of claim 11, wherein the program instructions further cause the processor set to:
identify the determined result is identical to the intercepted response, wherein the identification is based on the comparison of the intercepted response with the determined result; and
deploy the container object within the container platform based on the identification that the determined result is identical to the intercepted response.

16. The computer system of claim 15, wherein the program instructions further cause the processor set to:
generate a deployment request associated with the deployment of the container object within the container platform;
transmit the deployment request to the API server associated with the container platform; and
receive an acknowledgment from the API server, wherein the acknowledgment is indicative of a reception of the deployment request by the API server.

17. The computer system of claim 16, wherein the program instructions further cause the processor set to:
generate an alert based on the reception of the acknowledgment; and
output the generated alert on a user device.

18. A computer program product for controlling a deployment of a container object within a container platform, the computer program product comprising:
one or more computer-readable storage media; and
program instructions stored on the one or more computer-readable storage media to perform operations comprising:
intercepting a response to a request associated with the deployment of the container object within the container platform, wherein the response is transmitted from a set of admission controllers associated with the container platform;
retrieving one or more policies from a set of defined policies based on the request;
applying the one or more policies on the request;
determining a result based on the application of the one or more policies on the request, wherein the result is indicative of a denial of the request;
comparing the intercepted response with the determined result, wherein the comparison indicates that the determined result is different from the intercepted response;
identifying an anomaly associated with the set of admission controllers based on the comparison; and
controlling the deployment of the container object within the container platform based on the identified anomaly.

19. The computer program product of claim 18, wherein the program instructions stored on the one or more computer-readable storage media perform the operations further comprising:
retrieving the set of defined policies associated with the container platform;
identifying the one or more policies from the retrieved set of defined policies based on the request; and
retrieving the one or more policies from the set of defined policies based on the identification.

20. The computer program product of claim 18, wherein the program instructions stored on the one or more computer-readable storage media perform the operations further comprising:
identifying the determined result is different from the intercepted response, wherein the identification is based on the comparison of the intercepted response with the determined result;
identifying the anomaly associated with the set of admission controllers based on the identification that the determined result is different from the intercepted response;
executing a resolution process to rectify the identified anomaly associated with the set of admission controllers; and
deploying the container object within the container platform based on the execution of the resolution process.
